(19) United States
(12) Patent Application Publication
(10) Pub. No.: US 2019/0363555 A1
(43) Pub. Date: Nov. 28, 2019

(54) PORTABLE WIRELESS CHARGING APPARATUS

(71) Applicant: I/O INTERCONNECT, LTD., Santa Ana, CA (US)

(72) Inventors: Gary KUNG, Santa Ana, CA (US); Kuei-Jung Yang, Taipei (TW)

(21) Appl. No.: 15/987,027

(22) Filed: May 23, 2018

(51) Int. Cl. H02J 7/00; H02J 7/02

(52) U.S. Cl. CPC H02J 7/0044; H02J 7/025

(57) ABSTRACT

A portable wireless charging apparatus includes a housing, a first clamping member, a sliding member, a second clamping member, and a wireless charging module. The housing includes a top board and has an interior space therein. The first clamping member is connected to the housing and above the top board. The sliding member is slidably enclosing a portion of the top board. The second clamping member is connected to the sliding member. The sliding member is configured to move the second clamping member to adjust a distance between the first clamping member and the second clamping member. The wireless charging module is fixed to the housing and configured to charge an electronic device placed over the top board.

### BACKGROUND

### Technical Field

The present disclosure relates to a portable wireless charging apparatus.

### Description of Related Art

As the wireless charging technology matures and the charging efficiency improves, more portable electronic devices, such as, mobile phone, personal video player, digital camera, and so on, use wireless charging. The above electronic devices use a built-in receiving induction coil electrically connected to the battery, and a wireless charging apparatus is disposed with a built-in transmitting induction coil. When the transmitting and the receiving induction coils get close, the energy can be propagated according to the electromagnetic effect and electromagnetic resonance effect. After the electricity power transformation, the battery of the electronic device can be charged.

The conventional wireless charging apparatus often includes a power cord and a wireless charging pad. The wireless charging pad is for placing a wirelessly chargeable electronic device upon, and the power cord can be plugged into a socket through the plug at the end of the power cord. As such, the charging is performed through electromagnetic effect. Although convenient, the charging often must be conducted on a flat surface, such as a desk top, or some stable places devoid of shaking or swinging. Such wireless charging apparatus is often unsuitable for a mobile phone to stand in a tilt position or charging inside a moving vehicle. Therefore, the convenience issue must be re-addressed.

### SUMMARY

An aspect of the disclosure is to provide a portable wireless charging apparatus capable of fixing electronic devices during charging.

According to an embodiment of the disclosure, a portable wireless charging apparatus includes a housing, a first clamping member, a sliding member, a second clamping member, and a wireless charging module. The housing includes a top board and has an interior space therein. The first clamping member is connected to the housing and above the top board. The sliding member is slidably enclosing a portion of the top board. The second clamping member is connected to the sliding member. The sliding member is configured to move the second clamping member to adjust a distance between the first clamping member and the second clamping member. The a wireless charging module is fixed to the housing and configured to charge an electronic device placed over the top board.

In an embodiment of the disclosure, the sliding member is partially in the interior space. The portable wireless charging apparatus further includes a stopper. The stopper is in the interior space and configured to stop the sliding member from moving relative to the top board.

In an embodiment of the disclosure, the stopper includes an abutting portion and a shaft. The abutting portion is configured to abut against the sliding member. The shaft is rotatably disposed in the interior space and connected to the abutting portion.

In an embodiment of the disclosure, the portable wireless charging apparatus further includes a position recovery member. The position recovery member is in the interior space and configured to move the abutting portion toward the sliding member.

In an embodiment of the disclosure, the stopper further includes an extending portion. The extending portion is connected to the shaft. The position recovery member is connected to the extending portion.

In an embodiment of the disclosure, the position recovery member is a compression spring compressed between the top board and the extending portion.

In an embodiment of the disclosure, the sliding member has a first intermeshing portion. The stopper includes a second intermeshing portion configured to engage the first intermeshing portion.

In an embodiment of the disclosure, the housing further includes a bottom board having an opening connected to the interior space. The stopper includes a push button configured to partially protrude in the opening.

In an embodiment of the disclosure, the housing further includes a middle board. The middle board is connected to the top board, divides the interior space into a first subspace and a second subspace, and has a passage thereon. The sliding member is partially in the first subspace. The stopper is in the second subspace and configured to contact the sliding member via the passage.

In an embodiment of the disclosure, the housing further includes a side board connected to an edge of the top board. Each of the top board and the side board has an opening. The sliding member is configured to move into the interior space via one of the openings and move out of the interior space via another of the openings.

In an embodiment of the disclosure, the side board has a recess connected to the opening of the side board. The recess is configured to accommodate the second clamping member.

In an embodiment of the disclosure, when the second clamping member is accommodated in the recess, the second clamping member is below the top board.

In an embodiment of the disclosure, the housing further includes a middle board connected to the top board. A subspace of the interior space is defined between the top board and the middle board. The openings of the top board and the side board are connected to the subspace.

In an embodiment of the disclosure, the opening of the top board is between the first clamping member and the opening of the side board.

In an embodiment of the disclosure, the wireless charging module is at a side of the top board facing away from the interior space and substantially between the first clamping member and the opening of the top board.

In an embodiment of the disclosure, the wireless charging module is in the interior space and substantially between the openings of the top board and the side board.

In an embodiment of the disclosure, the portable wireless charging apparatus further includes a side board connected to an edge of the top board. The side board has a recess slidably engaged with the first clamping member and configured to accommodate the first clamping member.

In an embodiment of the disclosure, the housing further includes a side board connected to an edge of the top board and has a charging port. The portable wireless charging apparatus further includes a circuit board and a battery. The circuit board is electrically connected to the charging port and the wireless charging module. The battery is electrically connected to the circuit board.

In an embodiment of the disclosure, the top board has a first supporting surface facing away from the interior space and a second supporting surface recessed relative to the first supporting surface. The sliding member is partially above the second supporting surface.

In an embodiment of the disclosure, the first supporting surface is U-shaped. The second supporting surface is surrounded by the first supporting surface.

Accordingly, the portable wireless charging apparatus of the disclosure can fix electronic devices of different sizes by the first clamping member and the second clamping member above a supporting surface of the top board during charging, in which the distance between the first clamping member and the second clamping member can be adjusted by moving the sliding member to which the second clamping member is connected. Furthermore, the side board of the housing has recesses for accommodating the first clamping member and the second clamping member respectively below the supporting surface, so as to improve the portability of the portable wireless charging apparatus. In addition, the portable wireless charging apparatus of the disclosure can include more than one wireless charging module for charging the electronic devices of different sizes.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view illustrating a first operating state of a portable wireless charging apparatus according to some embodiments of the disclosure;

FIG. 1B is an exploded view of the portable wireless charging apparatus in FIG. 1A according to some embodiments of the disclosure;

FIG. 2 is a perspective view illustrating the portable wireless charging apparatus in FIG. 1A fixing a mobile phone according to some embodiments of the disclosure;

FIG. 3 is a perspective view illustrating the portable wireless charging apparatus in FIG. 1A fixing a wearable accessory according to some embodiments of the disclosure;

FIG. 4A is a perspective view illustrating a second operating state of the portable wireless charging apparatus in FIG. 1A according to some embodiments of the disclosure;

FIG. 4B is another perspective view of the portable wireless charging apparatus in FIG. 4A according to some embodiments of the disclosure;

FIG. 5A is a cross-sectional view of the portable wireless charging apparatus in FIG. 4A taken along line 5A-5A according to some embodiments of the disclosure, in which the stopper engages the sliding member; and

FIG. 5B is another cross-sectional view of the portable wireless charging apparatus in FIG. 4A taken along line 5A-5A according to some embodiments of the disclosure, in which the stopper releases the sliding member.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

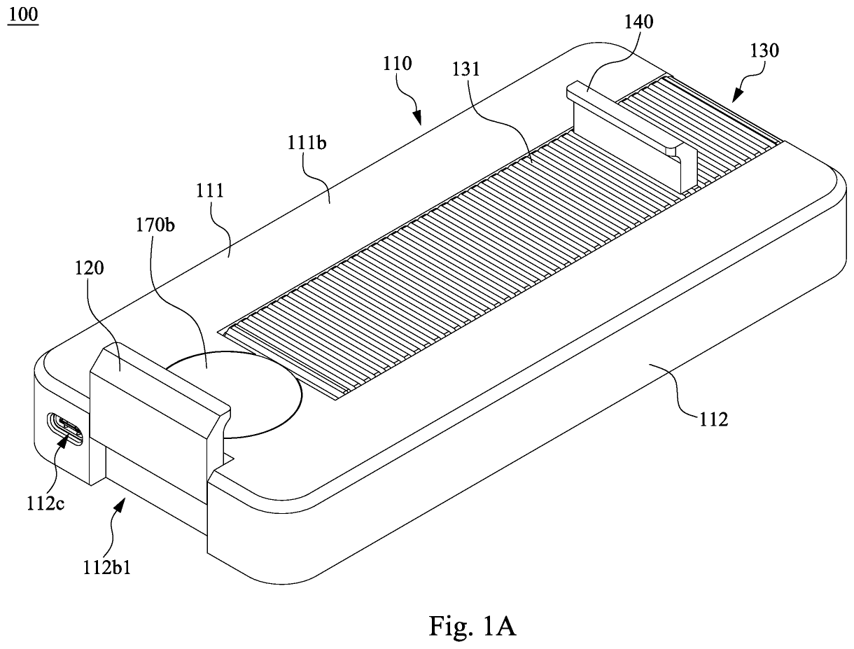

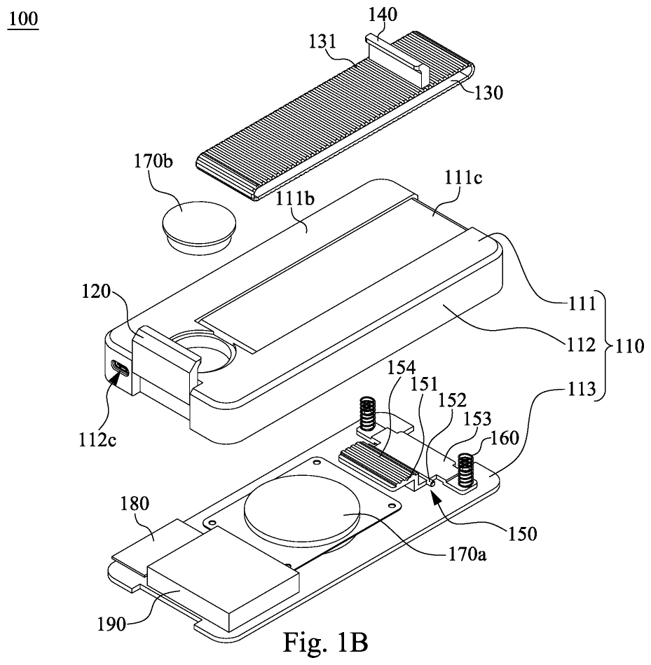

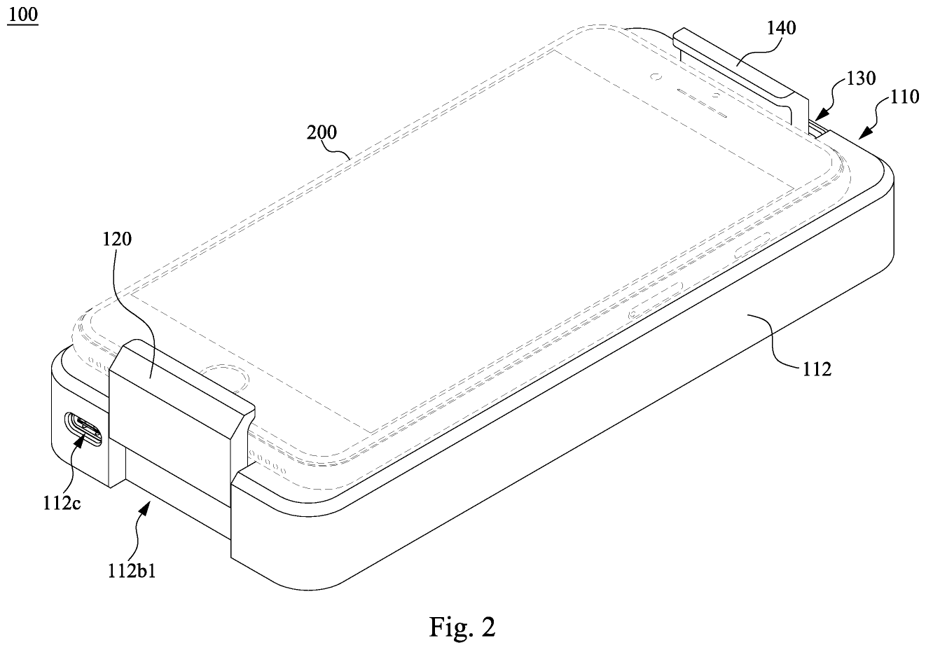

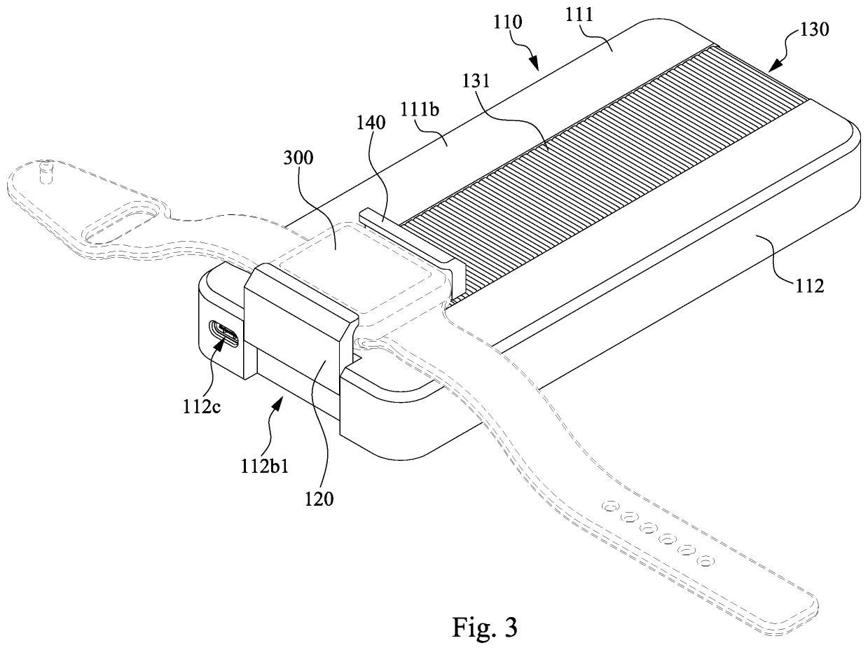

Reference is made to FIGS. 1A to 3. FIG. 1A is a perspective view illustrating a first operating state of a portable wireless charging apparatus 100 according to some embodiments of the disclosure. FIG. 1B is an exploded view of the portable wireless charging apparatus 100 in FIG. 1A according to some embodiments of the disclosure. FIG. 2 is a perspective view illustrating the portable wireless charging apparatus 100 in FIG. 1A fixing a mobile phone 200 according to some embodiments of the disclosure. FIG. 3 is a perspective view illustrating the portable wireless charging apparatus 100 in FIG. 1A fixing a wearable accessory 300 according to some embodiments of the disclosure. Structures and functions of components included in the portable wireless charging apparatus 100 and connection relationships among the components will be described in detail below.

As shown in FIGS. 1A and 1B, in some embodiments, the portable wireless charging apparatus 100 includes a housing 110, a first clamping member 120, a sliding member 130, and a second clamping member 140. The housing 110 includes a top board 111. The first clamping member 120 is connected to the housing 110 and above the top board 111. The sliding member 130 is slidably on the top board 111. The second clamping member 140 is connected to the sliding member 130. In the first operating state of the portable wireless charging apparatus 100, the first clamping member 120 and the second clamping member 140 are above the top board 111, and the sliding member 130 is configured to move the second clamping member 140 to adjust a distance between the first clamping member 120 and the second clamping member 140. As such, the portable wireless charging apparatus 100 can fix electronic devices of different sizes (e.g., the mobile phone 200 in FIG. 2 and the wearable accessory 300 in FIG. 3) by the first clamping member 120 and the second clamping member 140.

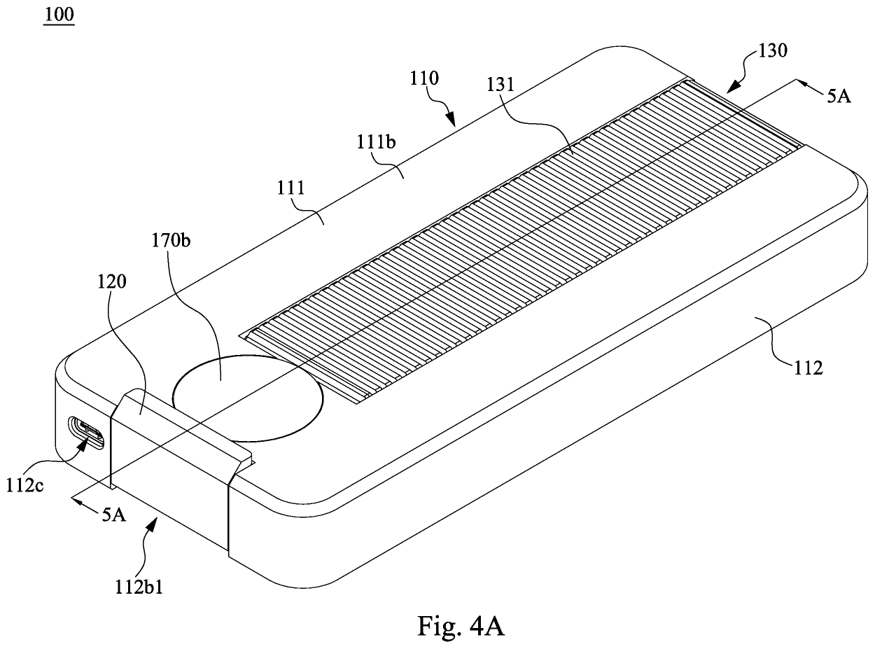

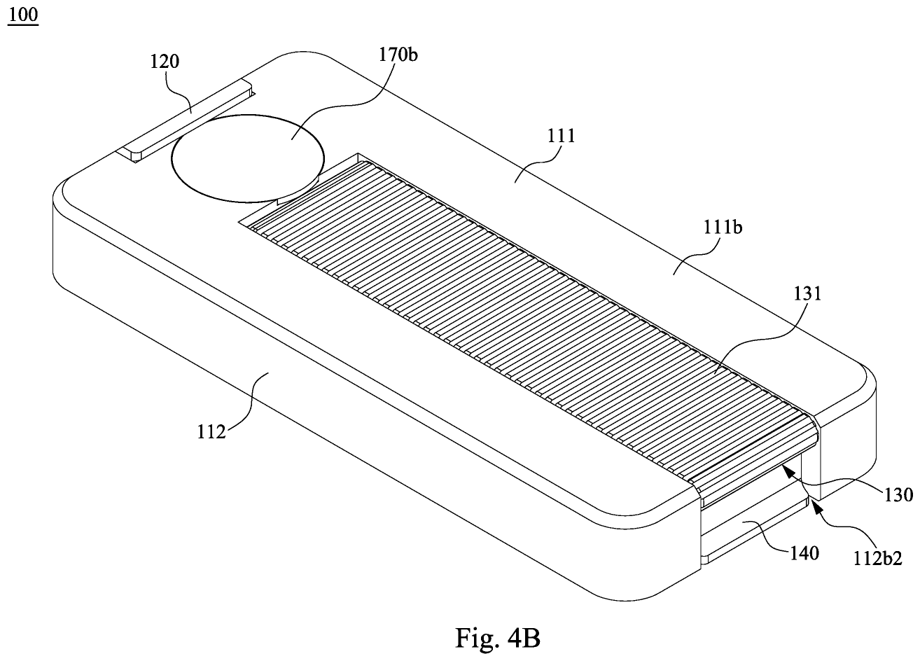

Reference is made to FIGS. 4A and 4B. FIG. 4A is a perspective view illustrating a second operating state of the portable wireless charging apparatus 100 in FIG. 1A according to some embodiments of the disclosure. FIG. 4B is another perspective view of the portable wireless charging apparatus 100 in FIG. 4A according to some embodiments of the disclosure.

As shown in FIGS. 1A and 4A, in some embodiments, the housing 110 further includes a side board 112 connected to an edge of the top board 111. The side board 112 has a recess 112b1 slidably engaged with the first clamping member 120. The recess 112b1 of the side board 112 is configured to accommodate the first clamping member 120 in the second operating state of the portable wireless charging apparatus 100. That is, the first clamping member 120 can slide relative to the recess 112b1 to adjust a height thereof above the top board 111. In some embodiments, the first clamping member 120 is slidable relative to the recess 112b1 along a direction substantially perpendicular to the top board 111, but the disclosure is not limited in this regard.

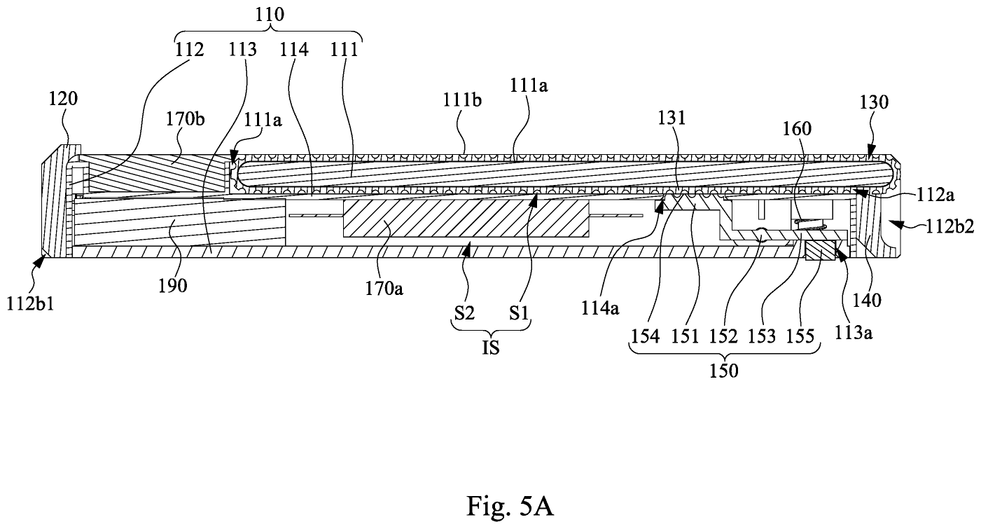

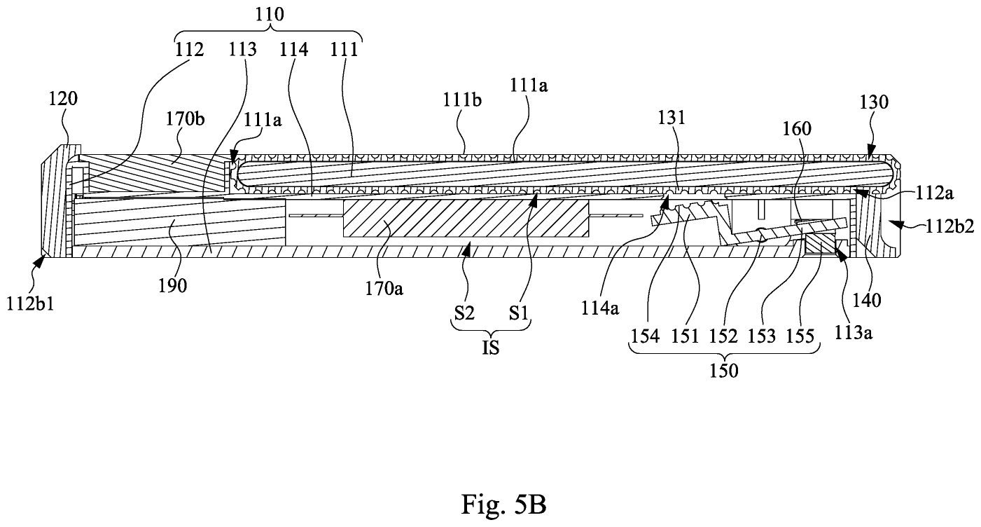

Reference is made to FIGS. 5A and 5B. FIG. 5A is a cross-sectional view of the portable wireless charging apparatus 100 in FIG. 4A taken along line 5A-5A according to some embodiments of the disclosure, in which the stopper 150 engages the sliding member 130. FIG. 5B is another cross-sectional view of the portable wireless charging apparatus 100 in FIG. 4A taken along line 5A-5A according to some embodiments of the disclosure, in which the stopper 150 releases the sliding member 130.

As shown in FIGS. 5A and 5B, in some embodiments, the housing 110 has an interior space IS therein. The top board 111 has an opening 111a. The side board 112 has an opening 112a. The opening 111a of the top board 111 is between the first clamping member 120 and the opening 112a of the side board 112. The sliding member 130 is slidably enclosing a portion of the top board 111 and configured to move into the interior space IS via one of the openings 111a, 112a and move out of the interior space IS via another of the openings 111a, 112a. That is, the sliding member 130 is in form of a conveyor belt and partially in the interior space IS. Therefore, the sliding member 130 can slide along a peripheral edge of said portion of the top board 111 and move the second clamping member 140 between the top board 111 and the side board 112.

Furthermore, as shown in FIG. 1B with reference to FIG. 5A, the top board 111 has a first supporting surface 111b facing away from the interior space IS and a second supporting surface 111c recessed relative to the first supporting surface 111b. The first supporting surface 111b is configured to support electronic devices to be fixed (e.g., the mobile phone 200 in FIG. 2 and the wearable accessory 300 in FIG. 3). A portion of the sliding member 130 outside the interior space IS is above the second supporting surface 111c and below (or substantially flushed with) the first supporting surface 111b. As such, the sliding member 130 will not friction with the electronic devices supported on the first supporting surface 111b of the top board 111.

In some embodiments as shown in FIG. 1B, the first supporting surface 111b is U-shaped. The second supporting surface 111c is surrounded by the first supporting surface 111b. As shown in FIG. 5A with reference to FIG. 1B, the opening 111a of the top board 111 and the opening 112a of the side board 112 are at opposite sides of the second supporting surface 111c, respectively. The opening 111a of the top board 111 is between the first supporting surface 111b and the second supporting surface 111c.

As shown in FIGS. 4B and 5A, in some embodiments, the side board 112 has another recess 112b2 connected to the opening 112a of the side board 112. The recess 112b2 is configured to accommodate the second clamping member 140 in the second operating state of the portable wireless charging apparatus 100. Specifically, when the second clamping member 140 is accommodated in the recess 112b2, the second clamping member 140 is below the top board 111. That is, the sliding member 130 can move the second clamping member 140 above and along the top board 111 or to be accommodated in the recess 112b2 of the side board 112. By accommodating the first clamping member 120 and the second clamping member 140 in the recesses 112b1, 112b2 of the side board 112 respectively in the in the second operating state, the space occupied by the entire portable wireless charging apparatus 100 can be reduced, so as to improve the portability of the portable wireless charging apparatus 100.

As shown in FIGS. 1B, 5A and 5B, in some embodiments, the portable wireless charging apparatus 100 further includes a stopper 150. The stopper 150 is in the interior space IS and configured to stop the sliding member 130 from moving relative to the top board 111. Specifically, the stopper 150 includes an abutting portion 151 and a shaft 152. The abutting portion 151 is configured to abut against the sliding member 130. The shaft 152 is connected to the abutting portion 151, rotatably disposed in the interior space IS, and connected to the abutting portion 151.

In some embodiments as shown in FIG. 5A, the sliding member 130 has a first intermeshing portion 131. The stopper 150 further includes a second intermeshing portion 154 formed on the abutting portion 151 and configured to engage the first intermeshing portion 131. Therefore, when the second intermeshing portion 154 of the stopper 150 is engaged with the first intermeshing portion 131 of the sliding member 130, the sliding member 130 is stopped from moving relative to the top board 111, so as to fix the position of the second clamping member 140 relative to the housing 110.

On the contrary, as shown in FIG. 5B, when the shaft 152 rotates to make the second intermeshing portion 154 leave the first intermeshing portion 131, the sliding member 130 is free to slide relative to the top board 111.

In some other embodiments, the first intermeshing portion 131 and the second intermeshing portion 154 can be omitted, and the abutting portion 151 can stop the sliding member 130 by the friction produced when the abutting portion 151 abuts against the sliding member 130.

In some embodiments as shown in FIGS. 1B and 5A, the portable wireless charging apparatus 100 further includes a position recovery member 160. The position recovery member 160 is in the interior space IS and configured to move the abutting portion 151 toward the sliding member 130.

In some embodiments as shown in FIGS. 1B and 5A, the stopper 150 further includes an extending portion 153. The extending portion 153 is connected to the shaft 152. The shaft 152 is connected between the abutting portion 151 and the extending portion 153. The position recovery member 160 is connected to the extending portion 153.

In some embodiments as shown in FIGS. 1B, 5A and 5B, the housing 110 further includes a bottom board 113. The bottom board 113 has an opening 113a connected to the interior space IS. The stopper 150 further includes a push button 155 connected to the extending portion 153 and configured to partially protrude in the opening 113a. As such, a user can press the push button 155 to rotate the entire stopper 150 (through the extending portion 153) about the shaft 152, so as to release the sliding member 130 from the stopper 150. When the user releases the push button 155, the position recovery member 160 rotates the entire stopper 150 (through the extending portion 153) about the shaft 152 to move the abutting portion 151 toward the sliding member 130, so as to stop the sliding member 130 from moving relative to the top board 111.

In some embodiments, the position recovery member 160 is a compression spring compressed between the top board 111 and the extending portion 153, but the disclosure is not limited in this regard. In some other embodiment, the position recovery member 160 can be a compression spring compressed between the bottom board 113 and the abutting portion 151. In some other embodiment, the position recovery member 160 can be a tension spring stretched between the extending portion 153 and the bottom board 113.

In some embodiments as shown in FIGS. 1B and 5A, the side board 112 has a charging port 112c. The portable wireless charging apparatus 100 further includes a circuit board 180, wireless charging modules 170a, 170b, and a battery 190. The circuit board 180 is in the interior space IS and electrically connected to the charging port 112c. The wireless charging modules 170a, 170b are fixed to the housing 110 and electrically connected to the circuit board 180. The wireless charging module 170a is in the interior space IS and substantially between the opening 111a of the top board 111 and the opening 112a of the side board 112. The wireless charging module 170a is in the interior space IS and configured to charge the mobile phone 200 shown in FIG. 2, for example. The wireless charging module 170b is at a side of the top board 111 facing away from the interior space IS (i.e., outside of the interior space IS) and substantially between the first clamping member 120 and the opening 111a of the top board 111. The wireless charging module 170b is configured to charge the wearable accessory 300 shown in FIG. 3, for example. The battery 190 is in the interior space IS and electrically connected to the circuit board 180. The circuit board 180 is configured to manage the power transmitted from the charging port 112c to the battery 190 and the power transmitted from the battery 190 to the wireless charging modules 170a, 170b.

As shown in FIGS. 5A and 5B, in some embodiments, the housing 110 further includes a middle board 114. The middle board 114 is connected to the top board 111, divides the interior space IS into a first subspace S1 and a second subspace S2, and has a passage 114a thereon. The first subspace S1 is defined between the top board 111 and the middle board 114. The opening 111a of the top board 111 and the opening 112a of the side board 112 are connected to the first subspace S1. The second subspace S2 is defined between the bottom board 113 and the middle board 114 and surrounded by the side board 112. The sliding member 130 is partially in the first subspace S1. The stopper 150 is in the second subspace S2 and configured to contact the sliding member 130 via the passage 114a of the middle board 114. In some embodiments, the stopper 150 entirely blocks the passage 114a while contacting the sliding member 130. As such, even if dust or liquid enters the first subspace S1 via the opening 111a of the top board 111 or the opening 112a of the side board 112, the dust or liquid may not enter the second subspace S2 via the passage 114a due to the blocking of the stopper 150, so as to prevent the components in the second subspace S2 (e.g., the circuit board 180, the wireless charging module 170a, and the battery 190) from damages caused by the dust or liquid.

According to the foregoing recitations of the embodiments of the disclosure, it can be seen that the portable wireless charging apparatus of the disclosure can fix electronic devices of different sizes by the first clamping member and the second clamping member above a supporting surface of the top board during charging, in which the distance between the first clamping member and the second clamping member can be adjusted by moving the sliding member to which the second clamping member is connected. Furthermore, the side board of the housing has recesses for accommodating the first clamping member and the second clamping member respectively below the supporting surface, so as to improve the portability of the portable wireless charging apparatus. In addition, the portable wireless charging apparatus of the disclosure can include more than one wireless charging module for charging the electronic devices of different sizes.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A portable wireless charging apparatus, comprising:
a housing comprising a top board and having an interior space therein;
a first clamping member connected to the housing and above the top board;
a sliding member slidably enclosing a portion of the top board;
a second clamping member connected to the sliding member, wherein the sliding member is configured to move the second clamping member to adjust a distance between the first clamping member and the second clamping member; and
a wireless charging module fixed to the housing and configured to charge an electronic device placed over the top board.

2. The portable wireless charging apparatus of claim 1, wherein the sliding member is partially in the interior space, and the portable wireless charging apparatus further comprises:
a stopper in the interior space and configured to stop the sliding member from moving relative to the top board.

3. The portable wireless charging apparatus of claim 2, wherein the stopper comprises:
an abutting portion configured to abut against the sliding member; and
a shaft rotatably disposed in the interior space and connected to the abutting portion.

4. The portable wireless charging apparatus of claim 3, further comprising a position recovery member in the interior space and configured to move the abutting portion toward the sliding member.

5. The portable wireless charging apparatus of claim 4, wherein the stopper further comprises an extending portion connected to the shaft, and the position recovery member is connected to the extending portion.

6. The portable wireless charging apparatus of claim 5, wherein the position recovery member is a compression spring compressed between the top board and the extending portion.

7. The portable wireless charging apparatus of claim 3, wherein the sliding member has a first intermeshing portion, and the stopper comprises a second intermeshing portion configured to engage the first intermeshing portion.

8. The portable wireless charging apparatus of claim 2, wherein the housing further comprises a bottom board having an opening connected to the interior space, and the stopper comprises a push button configured to partially protrude in the opening.

9. The portable wireless charging apparatus of claim 8, wherein the housing further comprises a middle board connected to the top board, dividing the interior space into a first subspace and a second subspace, and having a passage thereon, the sliding member is partially in the first subspace, and the stopper is in the second subspace and configured to contact the sliding member via the passage.

10. The portable wireless charging apparatus of claim 1, wherein the housing further comprises a side board connected to an edge of the top board, each of the top board and the side board has an opening, and the sliding member is configured to move into the interior space via one of the openings and move out of the interior space via another of the openings.

11. The portable wireless charging apparatus of claim 10, wherein the side board has a recess connected to the opening of the side board and configured to accommodate the second clamping member.

12. The portable wireless charging apparatus of claim 11, wherein when the second clamping member is accommodated in the recess, the second clamping member is below the top board.

13. The portable wireless charging apparatus of claim 10, wherein the housing further comprises a middle board connected to the top board, a subspace of the interior space is defined between the top board and the middle board, and the openings of the top board and the side board are connected to the subspace.

14. The portable wireless charging apparatus of claim 10, wherein the opening of the top board is between the first clamping member and the opening of the side board.

15. The portable wireless charging apparatus of claim 10, wherein the wireless charging module is at a side of the top board facing away from the interior space and substantially between the first clamping member and the opening of the top board.

16. The portable wireless charging apparatus of claim 10, wherein the wireless charging module is in the interior space and substantially between the openings of the top board and the side board.

17. The portable wireless charging apparatus of claim 1, further comprising a side board connected to an edge of the top board, wherein the side board has a recess slidably engaged with the first clamping member and configured to accommodate the first clamping member.

18. The portable wireless charging apparatus of claim 1, wherein the housing further comprises a side board connected to an edge of the top board and having a charging port, and the portable wireless charging apparatus further comprises:
a circuit board electrically connected to the charging port and the wireless charging module; and
a battery electrically connected to the circuit board.

19. The portable wireless charging apparatus of claim 1, wherein the top board has a first supporting surface facing away from the interior space and a second supporting surface recessed relative to the first supporting surface, and the sliding member is partially above the second supporting surface.

20. The portable wireless charging apparatus of claim 19, wherein the first supporting surface is U-shaped, and the second supporting surface is surrounded by the first supporting surface.
